(19) United States
(12) Patent Application Publication
(10) Pub. No.: US 2020/0081608 A1
(43) Pub. Date: Mar. 12, 2020

(54) DISPLAY CONTROL DEVICE

(71) Applicant: AISIN SEIKI KABUSHIKI KAISHA, Kariya-shi (JP)

(72) Inventors: Kinji YAMAMOTO, Anjo-shi (JP); Kazuya WATANABE, Anjo-shi (JP); Hiroyuki WATANABE, Chiryu-shi (JP)

(73) Assignee: AISIN SEIKI KABUSHIKI KAISHA, Kariya-shi (JP)

(21) Appl. No.: 16/563,012

(22) Filed: Sep. 6, 2019

(30) Foreign Application Priority Data
Sep. 7, 2018 (JP) 2018-168013

(51) Int. Cl. G06F 3/0484; G06T 3/40; B60R 1/00; G06T 11/40

(52) U.S. Cl. CPC G06F 3/04842; G06T 3/40; B60R 1/002; G06T 11/40; B60R 2300/607; G06T 2207/20101; G06T 2207/30252; B60R 2300/306; B60R 2300/307; G06F 2203/04806

(57) ABSTRACT

A display control device includes: an image acquisition unit configured to acquire captured image data from an imaging unit that captures an image of a peripheral area of a vehicle; a display control unit configured to display, on a screen, display image data based on the captured image data; and an operation receiving unit configured to receive an operation on the screen, in which the display control unit displays display information that reminds a first operation capable of being performed next via the operation receiving unit when the operation receiving unit receives designation of an arbitrary point of the display image data displayed on the screen.

### CROSS REFERENCE TO RELATED APPLICATIONS

This application is based on and claims priority under 35 U.S.C. § 119 to Japanese Patent Application 2018-168013, filed on Sep. 7, 2018, the entire contents of which are incorporated herein by reference.

### TECHNICAL FIELD

This disclosure relates to a display control device.

### BACKGROUND DISCUSSION

In the related art, there has been proposed a vehicle periphery monitoring device which causes a driver to recognize the situation around a vehicle by capturing an image of the periphery of the vehicle using a plurality of imaging units provided around the vehicle and combining a plurality of captured image data to generate and display a three-dimensional composite image on an in-vehicle display device (see, e.g., JP 2014-033469A (Reference 1)).

The related art described above has room for further improvement in terms of operability.

### SUMMARY

A display control device according to an aspect of this disclosure includes, for example, an image acquisition unit configured to acquire captured image data from an imaging unit that captures an image of a peripheral area of a vehicle, a display control unit configured to display, on a screen, display image data based on the captured image data, and an operation receiving unit configured to receive an operation on the screen, wherein the display control unit displays display information that reminds a first operation capable of being performed next via the operation receiving unit when the operation receiving unit receives designation of an arbitrary point of the display image data displayed on the screen.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a state where a portion of a vehicle cabin of a vehicle equipped with a display control device according to a first embodiment is seen through the vehicle;

FIG. 2 is a plan view illustrating an example of the vehicle equipped with the display control device according to the first embodiment;

FIG. 3 is a block diagram illustrating an example of a configuration of an ECU and a peripheral configuration thereof according to the first embodiment;

FIG. 4 is a diagram exemplifying a software configuration realized by the ECU according to the first embodiment;

FIG. 5 is a flow diagram illustrating an example of a procedure of enlargement control by a display control unit according to the first embodiment;

FIG. 6 is a flow diagram illustrating another example of a procedure of enlargement control by the display control unit according to the first embodiment;

FIG. 7 is a flow diagram illustrating an example of a procedure of interruption of enlargement control by the display control unit according to the first embodiment;

FIG. 8 is a flow diagram illustrating an example of a procedure of cancellation of enlargement control by the display control unit according to the first embodiment;

FIG. 9 is a flow diagram illustrating an example of a procedure of cancellation of enlargement control by the display control unit according to a first modification of the first embodiment;

FIG. 10 is a flow diagram illustrating an example of a procedure of viewpoint movement control by the display control unit according to a second modification of the first embodiment;

FIG. 11 is a flow diagram illustrating an example of a procedure of display switching control by the display control unit according to a third modification of the first embodiment;

FIG. 12 is a flow diagram illustrating an example of a procedure of brightness change control by the display control unit according to a fourth modification of the first embodiment;

FIGS. 13A and 13B are views illustrating another example of a brightness change icon displayed by the display control unit according to the fourth modification of the first embodiment;

FIG. 14 is a flow diagram illustrating an example of a control procedure at the time of driving by the display control unit according to a second embodiment;

FIG. 15 is a flow diagram illustrating an example of a control procedure at the time of backing by the display control unit according to the second embodiment; and

FIG. 16 is a flow diagram illustrating an example of a control procedure at the time of parking by the display control unit according to the second embodiment.

### DETAILED DESCRIPTION

Hereinafter, exemplary embodiments disclosed here will be disclosed. A configuration of the embodiments described below and actions, results, and effects caused by the configuration are given by way of example. The disclosure may be realized by a configuration other than the configuration disclosed in the following embodiments, and at least one of various effects based on a basic configuration and derivative effects may be obtained.

### First Embodiment

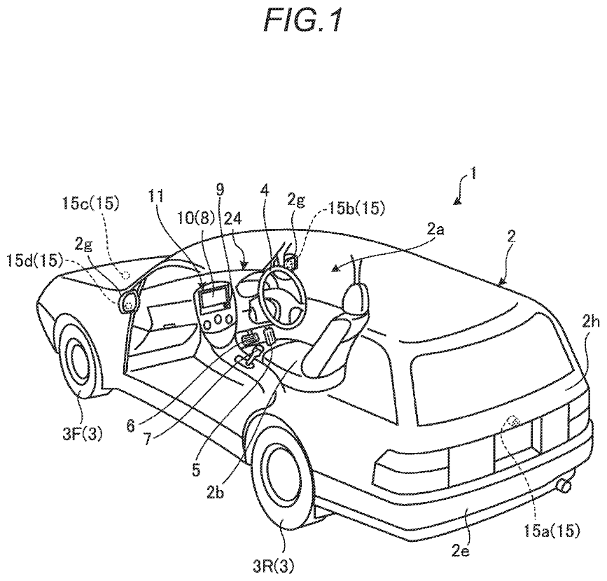

A first embodiment will be described with reference to FIGS. 1 to 13B.

### (Configuration of Vehicle)

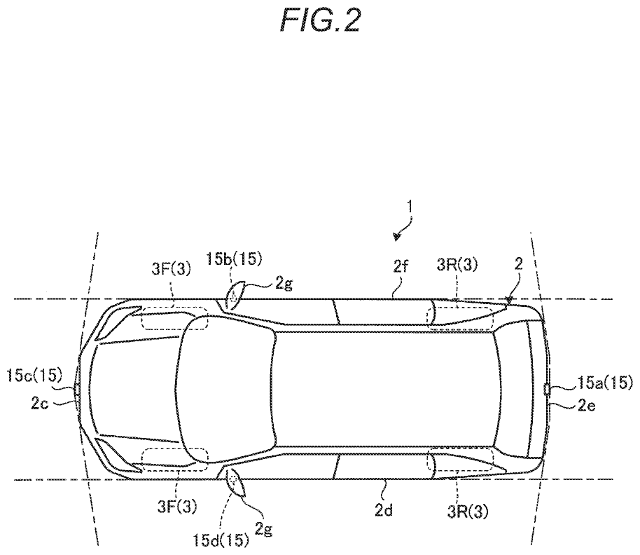

FIG. 1 is a perspective view illustrating an example of a state where a portion of a vehicle cabin 2a of a vehicle 1 equipped with a display control device according to a first embodiment is seen through the vehicle. FIG. 2 is a plan view illustrating an example of the vehicle 1 equipped with the display control device according to the first embodiment.

The vehicle 1 according to the first embodiment may be, for example, an automobile having an internal combustion engine as a drive source, i.e., internal combustion engine automobile, an automobile having an electric motor (not illustrated) as a drive source, i.e., an electric automobile or a fuel cell automobile, or a hybrid automobile having both the internal combustion engine and the electric motor as a drive source, or may be an automobile having any other drive source. Further, the vehicle 1 may be equipped with any of various speed-change devices, and may be equipped with various devices, for example, systems or components which are required for driving the internal combustion engine or the electric motor. Further, the type, the number, and the layout of devices related to the driving of wheels 3 in the vehicle 1 may be set in various ways.

As illustrated in FIG. 1, a vehicle body 2 configures the vehicle cabin 2a in which a passenger (not illustrated) gets. In the vehicle cabin 2a, a steering unit 4, an acceleration operation unit 5, a braking operation unit 6, a speed-change operation unit 7, and the like are provided in a state of facing a seat 2b of a driver as a passenger. The steering unit 4 is, for example, a steering wheel that protrudes from a dashboard 24. The acceleration operation unit 5 is, for example, an accelerator pedal that is located under the driver's feet. The braking operation unit 6 is, for example, a brake pedal that is located under the driver's feet. The speed-change operation unit 7 is, for example, a shift lever that protrudes from a center console. In addition, the steering unit 4, the acceleration operation unit 5, the braking operation unit 6, the speed-change operation unit 7, and the like are not limited thereto.

Further, in the vehicle cabin 2a, a display device 8 and a voice output device 9 are provided. The voice output device 9 is, for example, a speaker. The display device 8 is, for example, a liquid crystal display (LCD) or an organic electroluminescent display (OELD). The display device 8 is covered with a transparent operation input unit 10 such as a touch panel and the like. A passenger may visually recognize an image displayed on a display screen of the display device 8 through the operation input unit 10. Further, the passenger may execute an operation input by touching, pushing, or moving a position of the operation input unit 10 corresponding to the image displayed on the display screen of the display device 8 with the finger. For example, the display device 8, the voice output device 9, and the operation input unit 10 are provided, for example, in a monitor device 11 located at the center of the dashboard 24 in the vehicle width direction, i.e., in the transverse direction. The monitor device 11 may have an operation input unit (not illustrated) such as a switch, a dial, a joystick, or a push button. Further, a voice output device (not illustrated) may be provided at another position in the vehicle cabin 2a other than the monitor device 11. Furthermore, voice may be output from both the voice output device 9 of the monitor device 11 and the other voice output device. In addition, the monitor device 11 may also be used as, for example, a navigation system or an audio system.

As illustrated in FIGS. 1 and 2, the vehicle 1 is, for example, a four-wheel vehicle, and includes two left and right front wheels 3F and two left and right rear wheels 3R. All of these four wheels 3 may be configured to be steerable.

Further, the vehicle body 2 is, for example, provided with four imaging units 15a to 15d as a plurality of imaging units 15. The imaging unit 15 is, for example, a digital camera having an imaging element such as a charge coupled device (CCD) or a CMOS image sensor (CIS) incorporated therein. The imaging unit 15 may output captured image data at a predetermined frame rate. The captured image data may be moving image data. Each imaging unit 15 has a wide-angle lens or a fish-eye lens, and may capture an image within a range, for example, from 140° to 220° in the horizontal direction. Further, the optical axis of the imaging unit 15 may be set obliquely downward. Thus, the imaging unit 15 sequentially captures an image of the peripheral environment outside the vehicle 1 including the road surface on which the vehicle 1 is movable or an object, and outputs the captured image as captured image data. Here, the object is a rock, a tree, a person, a bicycle, or another vehicle, for example, which may become an obstacle, for example, at the time of driving of the vehicle 1.

The imaging unit 15a is located, for example, on a right end 2e of the vehicle body 2 and is provided on a wall portion below a rear window of a rear hatch door 2h. The imaging unit 15b is located, for example, on a right end 2f of the vehicle body 2 and is provided on a right door mirror 2g. The imaging unit 15c is located, for example, on the front side of the vehicle body 2, i.e., on a front end 2c in the longitudinal direction of the vehicle and is provided on a front bumper or a front grill. The imaging unit 15d is located, for example, on a left end 2d of the vehicle body 2 and is provided on a left door mirror 2g.

### (Hardware Configuration of ECU)

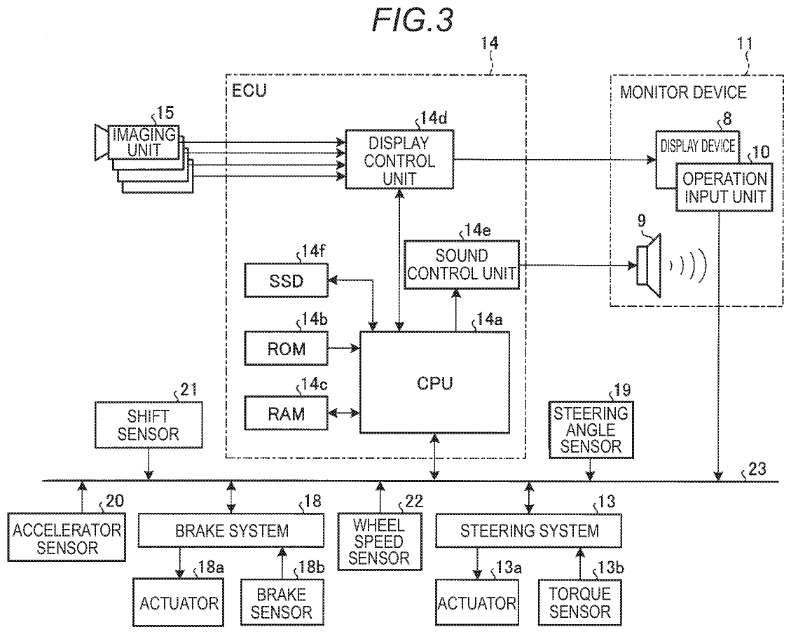

Next, an electronic control unit (ECU) 14 of the first embodiment and a peripheral configuration of the ECU 14 will be described with reference to FIG. 3. FIG. 3 is a block diagram illustrating a configuration of the ECU 14 and a peripheral configuration thereof according to the first embodiment.

As illustrated in FIG. 3, in addition to the ECU 14 as a display control device, the monitor device 11, a steering system 13, a brake system 18, a steering angle sensor 19, an accelerator sensor 20, a shift sensor 21, a wheel speed sensor 22, and the like are electrically connected via an in-vehicle network 23 as an electric communication line. The in-vehicle network 23 is configured with, for example, a controller area network (CAN).

The ECU 14 may control the steering system 13, the brake system 18, and the like by transmitting a control signal through the in-vehicle network 23. Further, the ECU 14 may receive, for example, detection results of a torque sensor 13b, a brake sensor 18b, the steering angle sensor 19, the accelerator sensor 20, the shift sensor 21, and the wheel speed sensor 22 or an operation signal of the operation input unit 10 through the in-vehicle network 23.

Further, the ECU 14 may execute an arithmetic processing or an image processing based on image data obtained by the plurality of imaging units 15 to generate an image with a wider viewing angle or to generate a virtual bird's-eye view image of the vehicle 1 as viewed from above. In addition, the bird's-eye view image may also be referred to as a planar image.

The ECU 14 includes, for example, a central processing unit (CPU) 14a, a read only memory (ROM) 14b, a random access memory (RAM) 14c, a display control unit 14d, a voice control unit 14e, and a solid state drive (SSD) 14f.

The CPU 14a may execute, for example, various arithmetic processings and various controls such as an image processing related to an image displayed on the display device 8, determination of a target position of the vehicle 1, calculation of a movement route of the vehicle 1, determination of the presence or absence of interference with an object, automatic control of the vehicle 1, and cancellation of automatic control. The CPU 14a may read a program which is installed and stored in a non-volatile storage device such as the ROM 14b, and may execute an arithmetic processing according to the program.

The RAM 14c temporarily stores various data used in calculation in the CPU 14a.

The display control unit 14d mainly executes an image processing using image data obtained by the imaging unit 15 or combination of image data displayed by the display device 8 among the arithmetic processings in the ECU 14.

The voice control unit 14e mainly executes a processing of voice data output from the voice output device 9 among the arithmetic processings in the ECU 14.

The SSD 14f is a rewritable non-volatile storage unit and may store data even when a power supply of the ECU 14 is turned off.

In addition, the CPU 14a, the ROM 14b, and the RAM 14c may be integrated in the same package. Further, the ECU 14 may be configured to use another logical operation processor such as a digital signal processor (DSP) or a logic circuit instead of the CPU 14a. Further, a hard disk drive (HDD) may be provided instead of the SSD 14f, and the SSD 14f or the HDD may be provided separately from the ECU 14.

The steering system 13 includes an actuator 13a and a torque sensor 13b and steers at least two wheels 3. That is, the steering system 13 is electrically controlled by the ECU 14 and the like to operate the actuator 13a. The steering system 13 is, for example, an electric power steering system or a steer-by-wire (SBW) system. The steering system 13 adds a torque, i.e., assistance torque to the steering unit 4 by the actuator 13a to supplement a steering force, or steers the wheel 3 by the actuator 13a. In this case, the actuator 13a may steer one wheel 3, or may steer a plurality of wheels 3. Further, the torque sensor 13b detects, for example, a torque that the driver gives to the steering unit 4.

The brake system 18 is, for example, an anti-lock brake system (ABS) that prevents locking of a brake, an electronic stability control (ESC) that prevents side slipping of the vehicle 1 during cornering, an electric brake system that increases a brake force to execute brake assistance, or a brake-by-wire (BBW). The brake system 18 applies a braking force to the wheel 3 and thus to the vehicle 1 via an actuator 18a. Further, the brake system 18 may execute various controls by detecting the locking of the brake, the idle rotation of the wheel 3, and the sign of side slipping from a difference in the rotation of the left and right wheels 3. The brake sensor 18b is, for example, a sensor that detects the position of a movable element of the braking operation unit 6. The brake sensor 18b may detect the position of a brake pedal as the movable element. The brake sensor 18b includes a displacement sensor.

The steering angle sensor 19 is, for example, a sensor that detects the steering amount of the steering unit 4 such as a steering wheel and the like. The steering angle sensor 19 is configured using a Hall element and the like. The ECU 14 acquires the steering amount of the steering unit 4 by the driver or the steering amount of each wheel 3 at the time of automatic steering from the steering angle sensor 19 to execute various controls. In addition, the steering angle sensor 19 detects the rotation angle of a rotating element included in the steering unit 4. The steering angle sensor 19 is an example of an angle sensor.

The accelerator sensor 20 is, for example, a sensor that detects the position of a movable element of the acceleration operation unit 5. The accelerator sensor 20 may detect the position of an accelerator pedal as the movable element. The accelerator sensor 20 includes a displacement sensor.

The shift sensor 21 is, for example, a sensor that detects the position of a movable element of the speed-change operation unit 7. The shift sensor 21 may detect the position of a lever, an arm, or a button as the movable element. The shift sensor 21 may include a displacement sensor, or may be configured as a switch.

The wheel speed sensor 22 is a sensor that detects the amount of rotation or the number of revolutions per unit time of the wheel 3. The wheel speed sensor 22 outputs a wheel speed pulse number indicating the detected number of revolutions as a sensor value. The wheel speed sensor 22 may be configured using, for example, a Hall element. The ECU 14 calculates the amount of movement of the vehicle 1 based on the sensor value acquired from the wheel speed sensor 22 to execute various controls. In addition, the wheel speed sensor 22 may be provided in the brake system 18 in some cases. In that case, the ECU 14 acquires the detection result of the wheel speed sensor 22 via the brake system 18.

In addition, the configuration, arrangement, and electrical connection form of various sensors or actuators described above are merely illustrative, and may be set and changed in various ways.

### (Software Configuration of ECU)

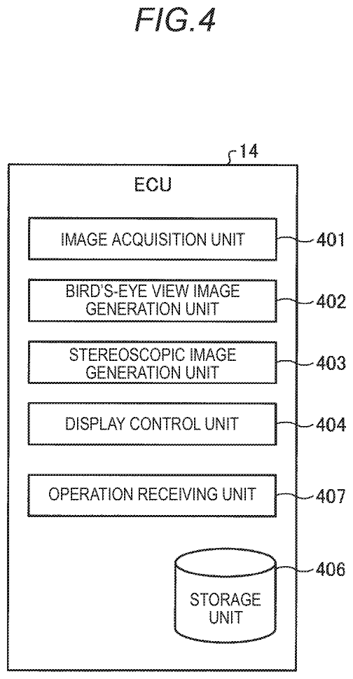

Next, a software configuration of the ECU 14 of the first embodiment will be described with reference to FIG. 4. FIG. 4 is a diagram exemplifying a software configuration realized by the ECU 14 according to the first embodiment.

As illustrated in FIG. 4, the ECU 14 includes an image acquisition unit 401, a bird's-eye view image generation unit 402, a stereoscopic image generation unit 403, a display control unit 404, a voice control unit 405, an operation receiving unit 407, and a storage unit 406. The CPU 14a functions as the image acquisition unit 401, the bird's-eye view image generation unit 402, the stereoscopic image generation unit 403, the display control unit 404, the voice control unit 405, or the operation receiving unit 407 by executing a processing according to a program. Further, the RAM 14c or the ROM 14b functions as the storage unit 406. In addition, at least some of the functions of the respective units may be realized by hardware. For example, the display control unit 404 may be realized by the display control unit 14d described above. Further, the voice control unit 405 may be realized by the voice control unit 14e described above. Further, the operation receiving unit 407 may be realized by the above-described operation input unit 10.

The image acquisition unit 401 acquires a plurality of captured image data from the plurality of imaging units 15 which capture an image of a peripheral area of the vehicle 1.

The bird's-eye view image generation unit 402 converts the captured image data acquired by the image acquisition unit 401 to generate bird's-eye view image data as composite image data based on a virtual viewpoint. As the virtual viewpoint, for example, it is conceivable to set a position that is upwardly spaced apart from the vehicle 1 by a predetermined distance. The bird's-eye view image data is image data generated by combining the captured image data acquired by the image acquisition unit 401, and is image data on which an image processing has been performed by the bird's-eye view image generation unit 402 so as to become display image data based on the virtual viewpoint. The bird's-eye view image data is image data indicating the periphery of the vehicle 1 from the bird's-eye viewpoint on the basis of a centrally disposed vehicle icon indicating the vehicle 1.

The stereoscopic image generation unit 403 generates virtual projection image data by projecting the captured image data acquired by the image acquisition unit 401 onto a virtual projection plane (three-dimensional shape model) surrounding the periphery of the vehicle 1 which is determined on the basis of the position where the vehicle 1 exists. Further, the stereoscopic image generation unit 403 disposes a vehicle shape model corresponding to the vehicle 1 stored in the storage unit 406 in a three-dimensional virtual space including the virtual projection plane. Thus, the stereoscopic image generation unit 403 generates stereoscopic image data as composite image data.

The display control unit 404 displays the captured image data acquired by the imaging unit 15 on the display device 8. Further, the display control unit 404 displays the bird's-eye view image data generated by the bird's-eye view image generation unit 402 on the display device 8. Further, the display control unit 404 displays the stereoscopic image data generated by the stereoscopic image generation unit 403 on the display device 8. Further, the display control unit 404 controls display content according to various user operations on the screen on which the captured image data, the bird's-eye view image data, the stereoscopic image data, and the like are displayed. Various controls by the display control unit 404 will be described later.

The voice control unit 405 combines an operation voice, various notification voices, and the like in the display device 8 and outputs the result to the voice output device 9.

The operation receiving unit 407 receives an operation by a user. For example, the operation receiving unit 407 may receive an operation input from the transparent operation input unit 10 provided on the display device 8, or may receive an operation from a switch or a dial. Furthermore, the operation receiving unit 407 may receive an operation from a touch pad provided as one corresponding to the display device 8.

The storage unit 406 stores data used in an arithmetic processing of each unit or data regarding the result of the arithmetic processing. Further, the storage unit 406 also stores various icons displayed by the display control unit 404, a vehicle shape model, voice data, and the like.

### (Enlargement by Display Control Unit)

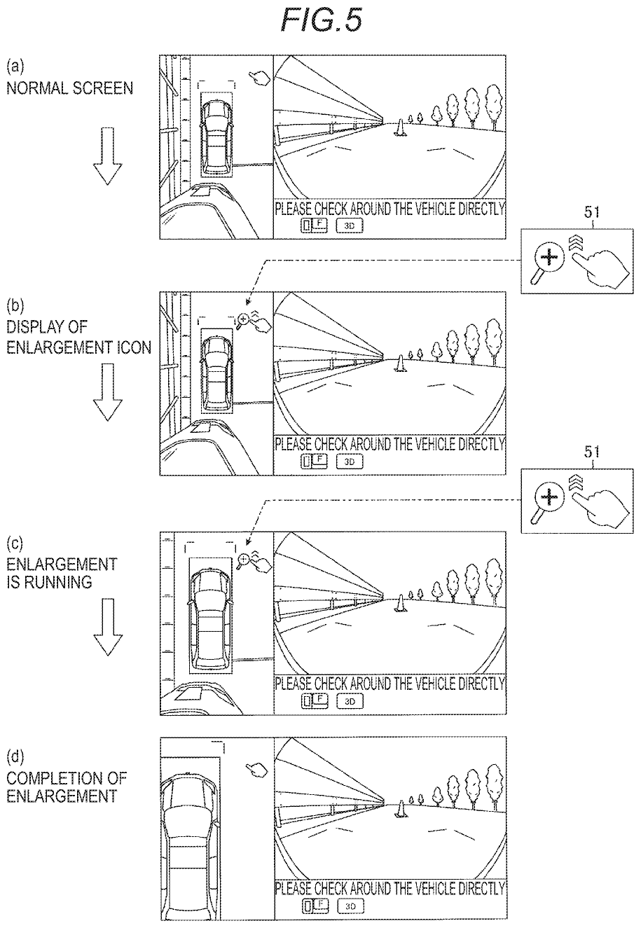

Next, among various controls by the display control unit 404, enlargement control in the display of bird's-eye view image data will be described with reference to FIG. 5. FIG. 5 is a flow diagram illustrating an example of a procedure of enlargement control by the display control unit 404 according to the first embodiment. In FIG. 5, it is assumed that the screen as an initial screen (normal screen) of the display device 8 is divided into two left and right sides. Bird's-eye view image data generated by the bird's-eye view image generation unit 402 is displayed on the left side. On the right side, for example, captured image data indicating the front of the vehicle 1 acquired by the imaging unit 15c on the front side of the vehicle 1 is displayed.

As illustrated in FIG. 5, the display control unit 404 may enlarge and display the bird's-eye view image data on the display device 8 by a predetermined user operation.

Specifically, as illustrated in (a) of FIG. 5, an arbitrary position of the area of the display device 8 where the bird's-eye view image data is displayed is designated by the user. The user may designate the arbitrary position by touching the position on the screen. The operation receiving unit 407 receives such designation from the user. Then, the display control unit 404 displays an enlargement icon 51 at the touch position of the display device 8, as illustrated in (b) of FIG. 5. The enlargement icon 51 includes display information that remands the user about an operation (first operation) that the user may perform next via the operation receiving unit 407 and display information indicating a control event to be performed when the operation that the user may perform next is received.

The enlargement icon 51 as display information includes, for example, a magnifying glass mark with “plus.” The enlargement icon 51 further includes a mark in which two inverted “V” letters are superimposed, and a finger mark attached thereto. The mark in which two inverted “V” letters are superimposed indicates an arrow pointing upward. In other words, the arrow mark and the finger mark remind an upward sliding operation (or dragging operation) as an operation that the user may perform next. Furthermore, these marks include information indicating a control event as first control that may occur when the operation receiving unit 407 receives an operation that the user further performs (the aforementioned operation that the user may perform next). Here, the control event is enlargement control in the display of the bird's-eye view image data. That is, the magnifying glass mark with “plus” of the enlargement icon 51 is display information indicating the control event (display information indicating enlargement control). In other words, the enlargement icon 51 includes a mark that reminds upward sliding operation (or dragging operation) that the user may perform next and a magnifying glass mark with “plus” indicating enlargement control (an example of control) to be performed when a sliding operation is received. Further, an operation to be performed next by the user in order to execute a control event, i.e., an operation to be received by the operation receiving unit 407 is to move the finger upward on the enlargement icon 51. The above-described user operation received by the operation receiving unit 407 may be sliding or dragging.

The user moves the finger upward on the enlargement icon 51 according to the enlargement icon 51. The operation receiving unit 407 receives the user operation, and as illustrated in (c) and (d) of FIG. 5, the display control unit 404 enlarges the display of the bird's-eye view image data to a predetermined magnification according to an amount by which the user moves the finger, i.e., the amount of sliding or the amount of dragging which is received by the operation receiving unit 407.

At this time, the display control unit 404 gradually changes the display of the bird's-eye view image data. Further, the display control unit 404 enlarges the display about the position which is designated by the user and is received by the operation receiving unit 407, i.e., the display position of the enlargement icon 51. At this time, the designated position received by the operation receiving unit 407 may be a fixed display position on the screen. That is, the display may be enlarged without moving the display position of the designated position received by the operation receiving unit 407. Alternatively, the display may be enlarged after the display position of the designated position received by the operation receiving unit 407 is moved to the center of the screen.

When the amount of sliding or the amount of dragging received by the operation receiving unit 407 is sufficiently large, as illustrated in (d) of FIG. 5, the display control unit 404 enlarges the display of the bird's-eye view image data to the maximum magnification and completes the enlargement control. When the enlargement control is completed, the enlargement icon 51 is hidden. However, the enlargement icon 51 may be hidden simultaneously with the start of the enlargement control.

Such enlargement control may also be performed on display of stereoscopic image data.

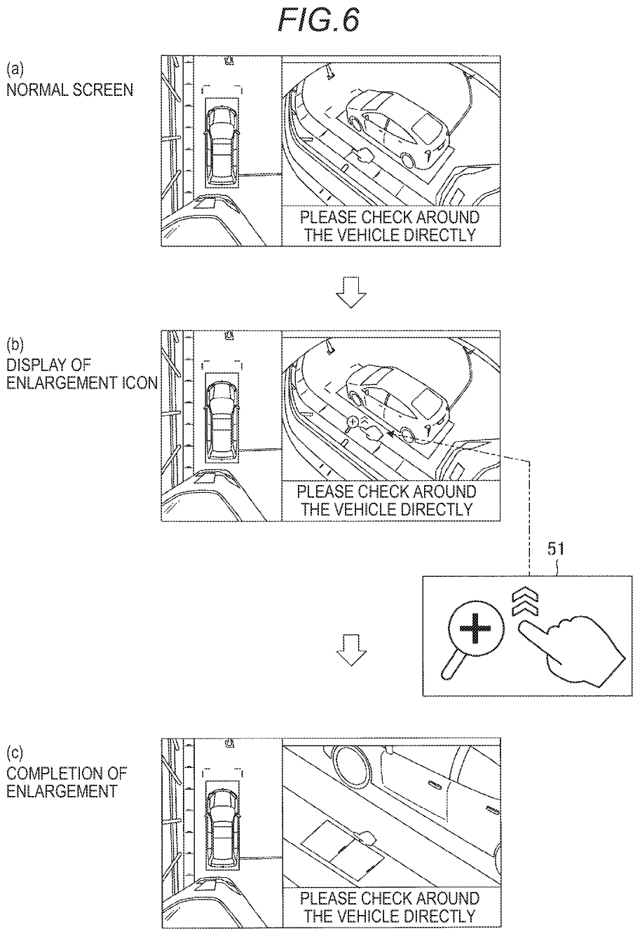

FIG. 6 is a flow diagram illustrating another example of a procedure of enlargement control by the display control unit 404 according to the first embodiment. In FIG. 6, the bird's-eye view image data generated by the bird's-eye view image generation unit 402 is displayed on the left side of the screen of the display device 8 which is divided into two left and right sides as an initial screen (normal screen). The stereoscopic image data generated by the stereoscopic image generation unit 403 is displayed on the right side.

As illustrated in (a) of FIG. 6, when the user touches an arbitrary position of the area of the display device 8 where the stereoscopic image data is displayed, the operation receiving unit 407 receives designation by the user's touch. In response to this, the display control unit 404 displays the enlargement icon 51 as display information at the touch position of the display device 8 as illustrated in (b) of FIG. 6. When the user performs upward sliding or dragging according to the enlargement icon 51, the operation receiving unit 407 receives such an operation, and as illustrated in (c) of FIG. 6, the display control unit 404 enlarges the display of the stereoscopic image data to a predetermined magnification according to the amount of sliding or the amount of dragging received by the operation receiving unit 407.

As described above, the display control unit 404 may also perform enlargement control in the display of the stereoscopic image data as in the display of the bird's-eye view image data. Hereinafter, other controls by the display control unit 404 will be mainly described by way of example of the display of the bird's-eye view image data, but the following various controls are also possible in the display of the stereoscopic image data.

### (Enlargement Interruption by Display Control Unit)

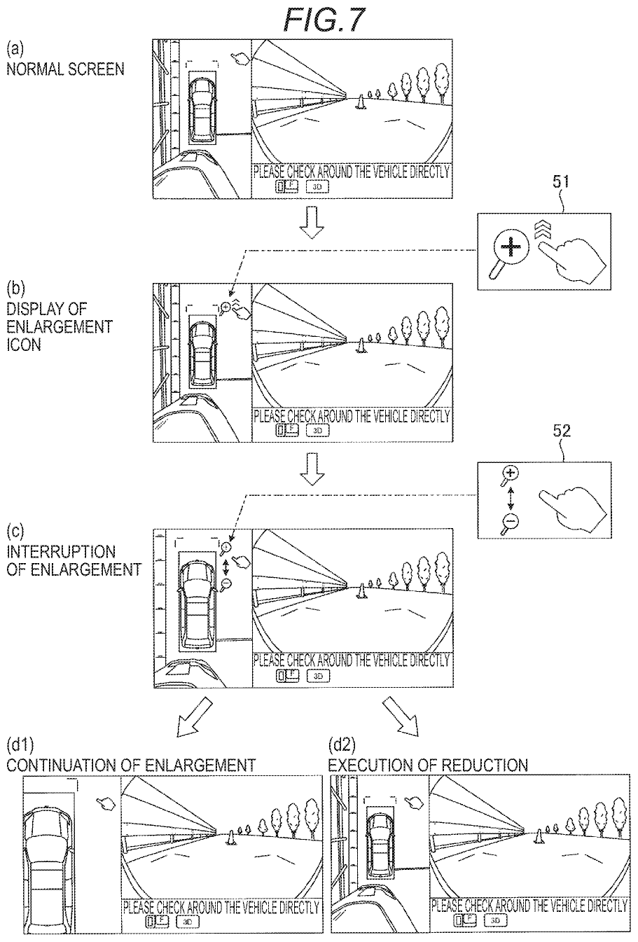

Next, interruption of display enlargement control of bird's-eye view image data by the display control unit 404 will be described with reference to FIG. 7. FIG. 7 is a flow diagram illustrating an example of a procedure of interruption of enlargement control by the display control unit 404 according to the first embodiment.

As illustrated in (a) of FIG. 7, when the user touches an arbitrary position of the area of the display device 8 where the bird's-eye view image data is displayed, the operation receiving unit 407 receives the operation, and as illustrated in (b) of FIG. 7, the display control unit 404 displays the enlargement icon 51 as display information at the touch position of the display device 8. When the user performs upward sliding or dragging according to the enlargement icon 51, the operation receiving unit 407 receives such an operation, and as illustrated in (c) of FIG. 7, the display control unit 404 enlarges the display of the bird's-eye view image data to a predetermined magnification according to the amount of sliding or the amount of dragging received by the operation receiving unit 407.

At this time, when the amount of sliding or the amount of dragging received by the operation receiving unit 407 does not reach the upper limit, the display control unit 404 interrupts enlargement control without setting the display of the bird's-eye view image data at the maximum magnification. Then, the display control unit 404 displays an enlargement and reduction icon 52 as display information at the touch position of the display device 8 received by the operation receiving unit 407.

The enlargement and reduction icon 52 includes a magnifying glass mark with “plus,” a magnifying glass mark with “minus,” an up-and-down arrow pointing to these marks, and a finger mark attached to the arrow. These marks include information indicating a control event that may occur when the user further performs an operation and the operation receiving unit 407 receives the operation. Here, the control event is continuation of enlargement control or cancellation of enlargement control. Canceling enlargement control indicates reducing the enlarged display of the bird's-eye view image data to a predetermined magnification. Here, the operation received by the operation receiving unit 407 is upward or downward sliding or dragging on the enlargement and reduction icon 52.

By upward sliding or dragging the user may cause the operation receiving unit 407 to receive the operation to continue enlargement control as illustrated in (d1) of FIG. 7. By downward sliding or dragging the user may cause the operation receiving unit 407 to receive the operation to cancel enlargement control and reduce the display as illustrated in (d2) of FIG. 7.

### (Enlargement Cancellation by Display Control Unit)

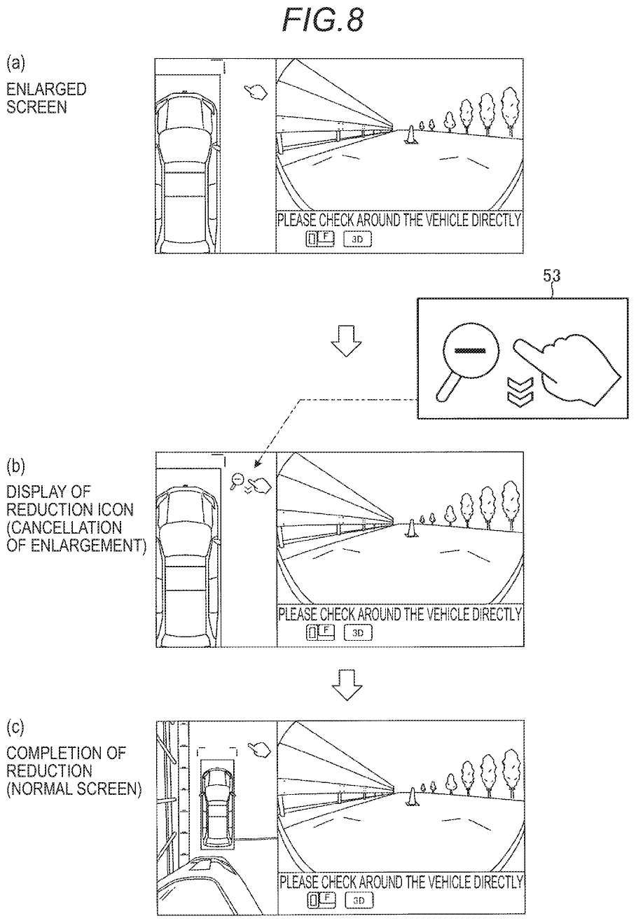

The above-described enlargement cancellation (reduction) may also be performed in the display enlarged to the maximum magnification. FIG. 8 is a flow diagram illustrating an example of a procedure of cancellation of enlargement control by the display control unit 404 according to the first embodiment.

As illustrated in (a) of FIG. 8, the display of the bird's-eye view image data on the left side is enlarged to the maximum magnification. When the user touches an arbitrary position of the area of the display device 8 where the bird's-eye view image data is displayed, the operation receiving unit 407 receives designation by the user's touch. In response to this, the display control unit 404 displays a reduction icon (enlargement cancellation icon) 53 as display information at the touch position of the display device 8 as illustrated in (b) of FIG. 8.

The reduction icon 53 includes a magnifying glass mark with “minus,” a mark in which two “V” letters are superimposed, and a finger mark attached thereto. These marks include information indicating a control event that may occur when the user further performs an operation. Here, the control event is cancellation of enlargement control, i.e., reduction of the display. The mark in which two “V” letters are superimposed means an arrow pointing downward. In other words, the arrow mark and the finger mark remind a downward sliding operation (or dragging operation) as an operation that the user may perform next. That is, here, the operation received by the operation receiving unit 407 is downward sliding or dragging on the reduction icon 53.

When the user performs downward sliding or dragging on the reduction icon 53 according to the reduction icon 53, the operation receiving unit 407 receives such an operation, and as illustrated in (c) of FIG. 8, the display control unit 404 reduces the display of the bird's-eye view image data to a predetermined magnification according to the amount of sliding or the amount of dragging received by the operation receiving unit 407.

At this time, the display control unit 404 gradually changes the display of the bird's-eye view image data. Further, the display control unit 404 reduces the display about the position which is designated by the user and is received by the operation receiving unit 407, i.e., the display position of the reduction icon 53. At this time, the designated position received by the operation receiving unit 407 may have a fixed display position on the screen. That is, the display may be reduced without moving the display position of the designated position received by the operation receiving unit 407. Alternatively, the display may be reduced after moving the display position of the designated position received by the operation receiving unit 407 to the center of the screen.

When the amount of sliding or the amount of dragging received by the operation receiving unit 407 is sufficiently large, as illustrated in (c) of FIG. 8, the display control unit 404 reduces the display of the bird's-eye view image data to the minimum magnification and completes cancellation of enlargement control. When cancellation of enlargement control is completed, the reduction icon 53 is hidden. However, the reduction icon 53 may be hidden simultaneously with the start of cancellation of the enlargement control.

### Comparative Example

For example, in the configuration of Reference 1 described above, an image of the area designated by an operation of touching any one area of a bird's-eye view image display area is enlarged and displayed as an enlargement target image in the bird's-eye view image display area. However, in the configuration of Reference 1, it is difficult to know an operation method since no operation icon is displayed. Further, since no operation icon is displayed and only a touch operation is possible, operations of only two patterns including enlargement and enlargement cancellation may be performed. Further, since a predetermined divided area is enlarged at a predetermined magnification, it is not possible to enlarge an arbitrary position at an arbitrary magnification.

According to the ECU 14 of the first embodiment, the display control unit 404 displays various icons 51 to 53 as display information. This may remind the user about an operation that the user may perform next. Thus, the user may intuitively understand an operation method and may cause the display control unit 404 to execute desired display control. As described above, according to the ECU 14 of the first embodiment, it is possible to improve the operability of displaying composite image data such as bird's-eye view image data and stereoscopic image data.

According to the ECU 14 of the first embodiment, the display control unit 404 determines an enlargement magnification or a reduction magnification according to the amount of sliding or the amount of dragging on the display device 8 received by the operation receiving unit 407. Thus, the user may enlarge or reduce the display of composite image data such as bird's-eye view image data and stereoscopic image data at an arbitrary magnification.

According to the ECU 14 of the first embodiment, the display control unit 404 enlarges or reduces the display about the designated position received by the operation receiving unit 407. This allows the user to enlarge or reduce an arbitrary position at an arbitrary magnification.

According to the ECU 14 of the first embodiment, the display control unit 404 displays various icons 51 to 53 when an arbitrary position is received by the operation receiving unit 407. Thus, there is no need to constantly display, for example, an operation icon on the screen.

According to the ECU 14 of the first embodiment, the operation receiving unit 407 receives an operation such as touching, sliding, or dragging on the screen by the user. Thus, even in a multi-tap non-compatible monitor that does not provide pinch-in or pinch-out, it is possible to perform enlargement and reduction operations at an arbitrary position with a single tap.

Hereinafter, various modifications of the first embodiment will be described. In the following description, components of various modifications corresponding to the first embodiment will be denoted by the same reference numerals with reference to FIGS. 1 to 4.

### (First Modification)

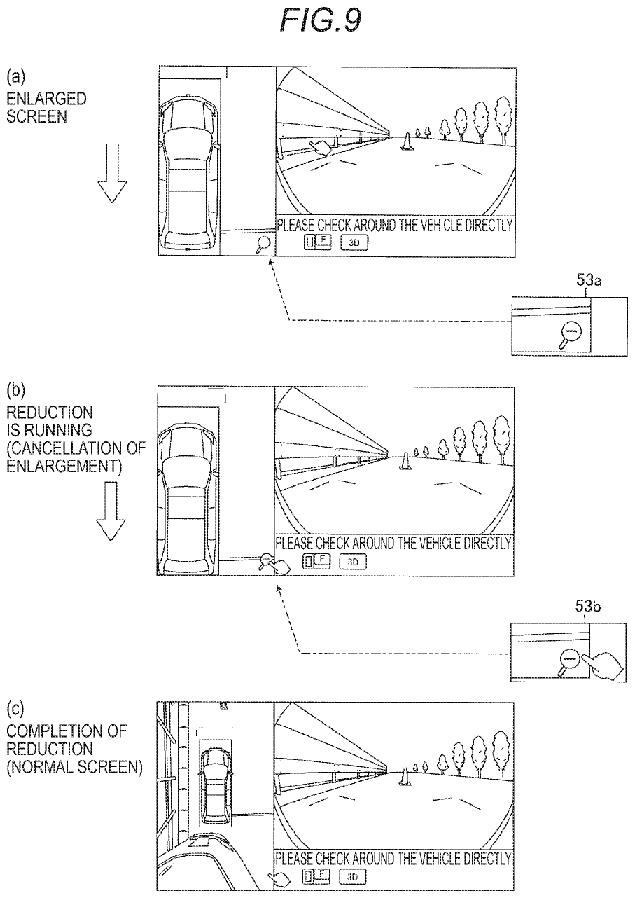

Another procedure of cancellation of enlargement control will be described with reference to FIG. 9. FIG. 9 is a flow diagram illustrating an example of a procedure of cancellation of enlargement control by the display control unit 404 according to a first modification of the first embodiment. The example of the first modification differs from the above-described first embodiment in that a reduction icon 53a is fixed at a predetermined position on the screen.

As illustrated in (a) of FIG. 9, the display of the bird's-eye view image data on the left side is enlarged to the maximum magnification. At this time, the reduction icon 53a as display information is displayed at a predetermined position on the enlarged screen. The predetermined position is a fixed position on the enlarged screen, and in the example of (a) of FIG. 9, is at the lower right side of the display area of the bird's-eye view image data. The reduction icon 53a has a magnifying glass mark with “minus.”

When the user touches the display position of the reduction icon 53a, the operation receiving unit 407 receives such an operation, and as illustrated in (b) of FIG. 9, the display control unit 404 starts cancellation of enlargement control. Further, a reduction icon 53b in which a finger mark is attached to a magnifying glass mark with “minus,” indicating the start of cancellation of enlargement control, is displayed in an active state. Then, as illustrated in (c) of FIG. 9, the display control unit 404 reduces the display of the bird's-eye view image data to the minimum magnification, and completes cancellation of enlargement control. When cancellation of enlargement control is completed, the reduction icon 53a is hidden. However, the reduction icon 53a may be hidden simultaneously with the start of cancellation of enlargement control.

According to the ECU 14 of the first modification of the first embodiment, the display control unit 404 displays the reduction icon 53a fixed at a predetermined position on the screen as the enlarged screen. Thus, a touch operation at an arbitrary position on the enlarged screen may be assigned to another action.

### (Second Modification)

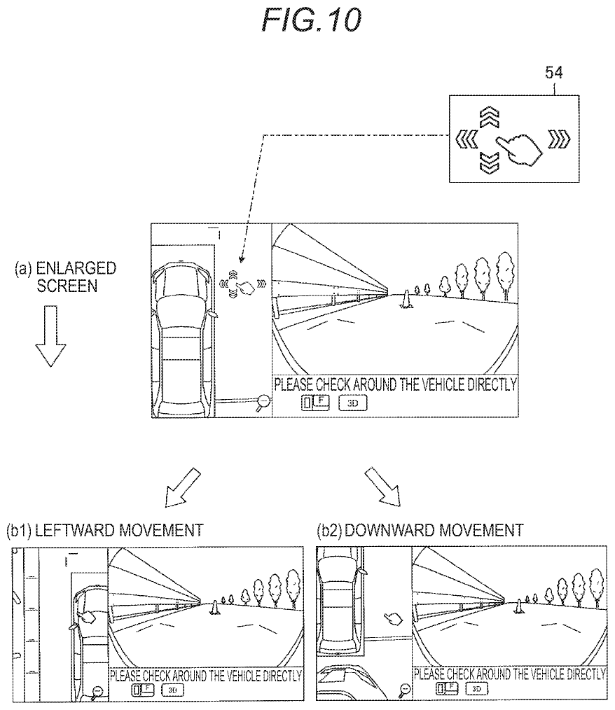

An example in which a touch operation at an arbitrary position on the enlarged screen is assigned to an action other than cancellation of enlargement control will be described with reference to FIG. 10. FIG. 10 is a flow diagram illustrating an example of a procedure of viewpoint movement control by the display control unit 404 according to a second modification of the first embodiment.

As illustrated in (a) of FIG. 10, the display of the bird's-eye view image data on the left side is enlarged to the maximum magnification. When the user touches an arbitrary position of the area of the display device 8 where the bird's-eye view image data is displayed, the operation receiving unit 407 receives designation by the user's touch. In response to this, the display control unit 404 displays a viewpoint movement icon 54 as display information at the touch position of the display device 8.

The viewpoint movement icon 54 includes a mark in which two “V” letters are superimposed, a mark in which two inverted “V” letters are superimposed, and marks in which two “V” letters rotated to the left side or the right side are superimposed, and a finger mark attached thereto. These marks indicate directions in which the user may perform a dragging operation as an operation that the user may perform next, and include information indicating a control event that may occur when the user further performs the operation and the operation receiving unit 407 receives the operation. Here, the control event is scroll (or viewpoint movement) control (in the upward, downward, leftward, or rightward direction) in the display of bird's-eye view image data. Here, the operation received by the operation receiving unit 407 is to move the finger upward, downward, leftward, or rightward. Such an operation received by the operation receiving unit 407 may be dragging or flicking. The display control unit 404 moves the display of the bird's-eye view image data in the dragging direction or the flicking direction according to the amount of dragging or the intensity of flicking.

For example, when the user performs dragging or flicking rightward, the operation receiving unit 407 receives such an operation, and as illustrated in (b1) of FIG. 10, the display control unit 404 moves the viewpoint in the display of the bird's-eye view image data leftward. That is, initially, the designated position received by the operation receiving unit 407 is moved leftward by the touch of the user.

Further, for example, when the user performs downward dragging or flicking, the operation receiving unit 407 receives such an operation, and as illustrated in (b2) of FIG. 10, the display control unit 404 moves the viewpoint in the display of the bird's-eye view image data upward. That is, initially, the designated position received by the operation receiving unit 407 is moved upward by the touch of the user.

According to the ECU 14 of the second modification of the first embodiment, the display control unit 404 moves the viewpoint in the display of the bird's-eye view image data when the operation receiving unit 407 receives the user operation on the viewpoint movement icon 54. Thus, the enlargement position may be easily changed.

### (Third Modification)

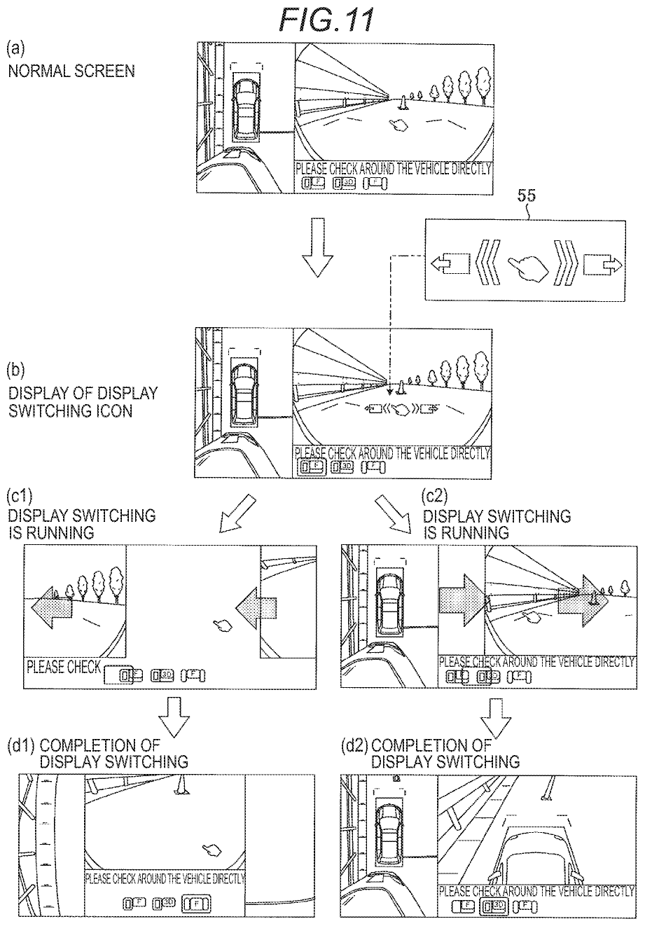

Next, display switching control will be described with reference to FIG. 11. FIG. 11 is a flow diagram illustrating an example of a procedure of display switching control by the display control unit 404 according to a third modification of the first embodiment.

In the example of the third modification, the display on the right side of the bisected screen is switched so that another screen is displayed. The display that may be switched is, for example, captured image data around the vehicle 1 captured by the imaging unit 15 or stereoscopic image data generated by the stereoscopic image generation unit 403.

As illustrated in (a) of FIG. 11, for example, captured image data acquired by a predetermined imaging unit 15 is displayed on the right side of the screen. At this time, a plurality of screen icons indicating respective screens the display of which may be switched are displayed in a lower region of the screen. When the user touches an arbitrary position of the area of the display device 8 where the captured image data is displayed, the operation receiving unit 407 receives such an operation, and as illustrated in (b) of FIG. 11, the display control unit 404 displays a display switching icon 55 as display information at the touch position of the display device 8. At this time, an icon frame is attached to the screen icon indicating a current display screen among the screen icons displayed in the lower region of the screen. In addition, when the screen is not capable of switching display, the operation receiving unit 407 does not receive a user operation even when the user performs a touch operation, and the display control unit 404 does not display the display switching icon 55.

The display switching icon 55 includes marks in which two “V” letters rotated to the left side or the right side are superimposed, a finger mark attached thereto, rectangles indicating screens in the directions pointed by the “V” letters, and arrows indicating the sliding direction of the screen. These marks include information indicating a control event that may occur when the user further performs an operation and the operation receiving unit 407 receives such an operation. Here, the control event is display switching control. Here, the operation received by the operation receiving unit 407 is to move the finger leftward or rightward. Such an operation received by the operation receiving unit 407 may be swiping, dragging, flicking, or the like. The display control unit 404 slides the screen of the captured image data in the swiping direction, the dragging direction, or the flicking direction according to the amount of swiping, the amount of dragging, or the intensity of flicking and further slides another adjacent screen on the display device 8 to switch the display.

For example, when the user performs leftward swiping, dragging or flicking, the operation receiving unit 407 receives such an operation, and as illustrated in (c1) of FIG. 11, the display control unit 404 moves the screen of the captured image data that is being displayed leftward. Then, for example, captured image data acquired by another imaging unit 15 appears from the right end of the screen. At this time, an icon frame attached to the screen icons in the lower region of the screen slides to match the sliding of the screen. As illustrated in (d1) of FIG. 11, when the captured image data is moved to the swiping position, the dragging position, or the flicking position, the display control unit 404 completes the display switching control. At this time, the icon frame is moved to the screen icon indicating the switched screen among the screen icons in the lower region of the screen.

For example, when the user performs rightward swiping, dragging, or flicking, the operation receiving unit 407 receives such an operation, and as illustrated in (c2) of FIG. 11, the display control unit 404 moves the screen of the captured image data that is being displayed rightward. Then, for example, stereoscopic image data generated by the stereoscopic image generation unit 403 appears from the left end of the screen. At this time, the icon frame attached to the screen icons in the lower region of the screen slides to match the sliding of the screen. As illustrated in (d2) of FIG. 11, when the stereoscopic image data is moved to the swiping position, the dragging position, or the flicking position, the display control unit 404 completes the display switching control. At this time, the icon frame is moved to the screen icon indicating the switched screen among the screen icons in the lower region of the screen.

In addition, regardless of the example of FIG. 11, the icon frame may not be displayed, and the sliding of the icon frame may not be performed. This is because it is possible to know the screen the display of which may be switched by simply displaying a plurality of screen icons, and thus, it is possible to perform screen switching with reference to the screen icons.

### (Fourth Modification)

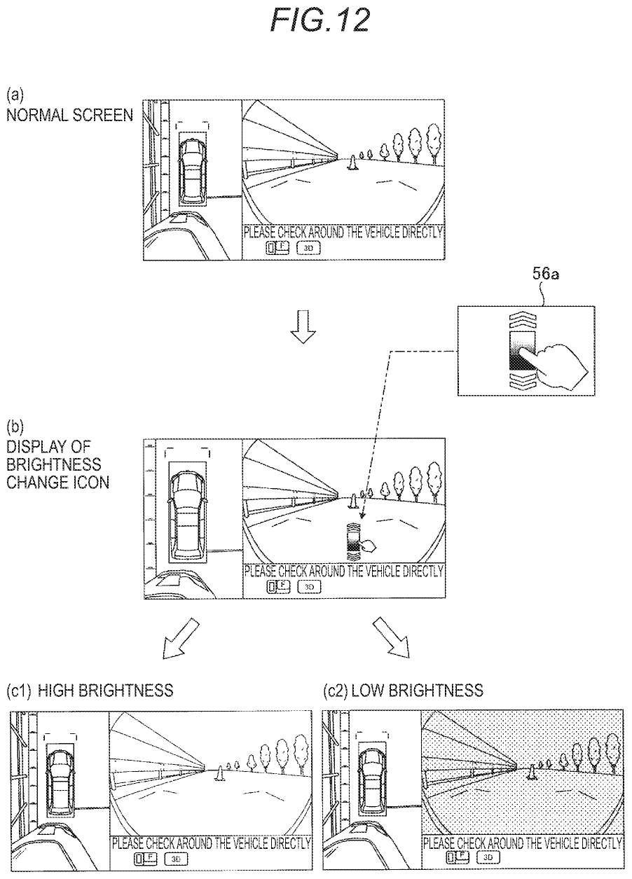

Next, brightness change control will be described with reference to FIG. 12. FIG. 12 is a flow diagram illustrating an example of a procedure of brightness change control by the display control unit 404 according to a fourth modification of the first embodiment.

As illustrated in (a) of FIG. 12, for example, when the user touches an arbitrary position of the area of the display device 8 where the captured image data is displayed, the operation receiving unit 407 receives such an operation, and as illustrated in (b) of FIG. 12, the display control unit 404 displays a brightness change control icon 56a as display information at the touch position of the display device 8.

The brightness change control icon 56a includes a rectangular mark with gradation, a mark in which two “V” letters are superimposed, a mark in which two inverted “V” letters are superimposed, and a finger mark attached thereto. These marks include information indicating a control event that may occur when the user further performs an operation and the operation receiving unit 407 receives such an operation. Here, the control event is a change in brightness in the display of the captured image data. Here, the operation received by the operation receiving unit 407 is upward or downward dragging or flicking. The display control unit 404 changes the brightness in the display of the captured image data according to the amount of dragging or the intensity of flicking.

For example, when the user performs upward dragging or flicking, the operation receiving unit 407 receives such an operation, and as illustrated in (c1) of FIG. 12, the display control unit 404 raises the brightness in the display of the captured image data. In other words, the display control unit 404 makes the screen display brighter.

Further, for example, when the user performs downward dragging or flicking, the operation receiving unit 407 receives such an operation, and as illustrated in (c2) of FIG. 12, the display control unit 404 lowers the brightness in the display of the captured image data. In other words, the display control unit 404 darkens the screen display.

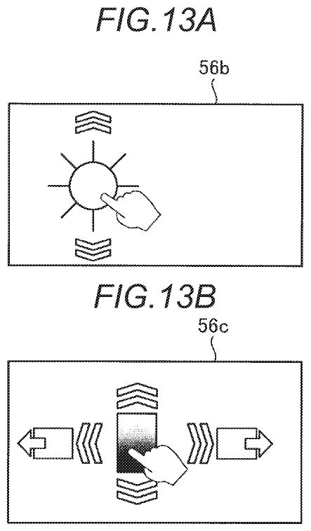

In addition, the display control unit 404 of the fourth modification may display a brightness change control icon 56b illustrated in FIG. 13A. The brightness change control icon 56b includes a circular mark having a plurality of radially extending lines instead of the rectangular mark with gradation. By such a brightness change control icon 56b, it is possible to remind the user about the operation that the user may perform next, and the operation receiving unit 407 may receive, i.e., a change in brightness.

Moreover, as illustrated in FIG. 13B, a brightness change control display switching icon 56c in which the display switching icon 55 of the third modification and the brightness change control icon 56a are combined may be displayed. In the brightness change control display switching icon 56c, when the operation receiving unit 407 receives leftward or rightward movement, display switching is performed, and when the operation receiving unit 407 receives upward or downward movement, a change in brightness is performed. Thus, for example, a change in the brightness of the display screen may be rapidly realized immediately after display switching.

### Second Embodiment

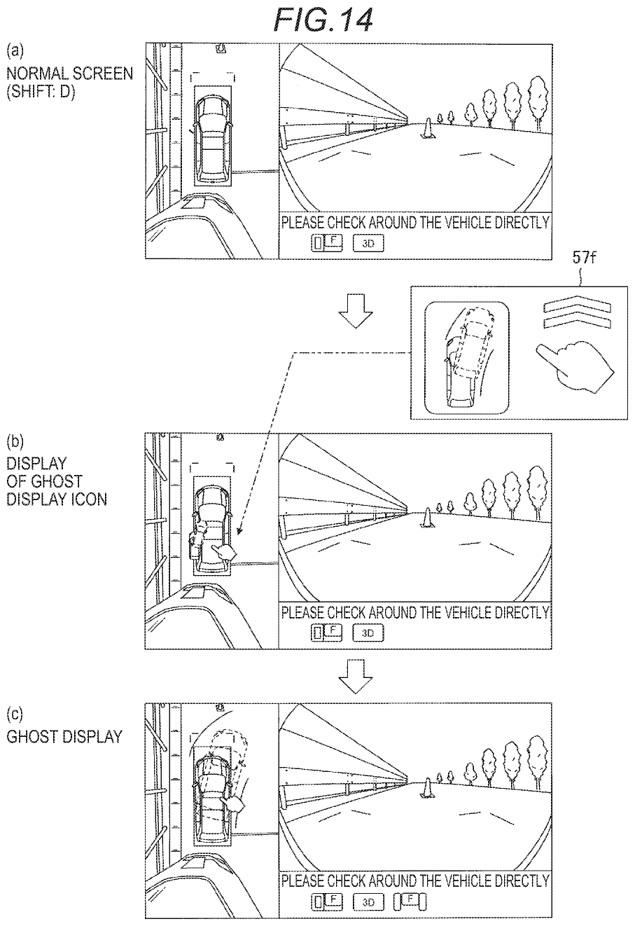

A second embodiment will be described with reference to FIGS. 14 to 16. In the following description, similarly, components of the second embodiment corresponding to the first embodiment will be denoted by the same reference numerals with reference to FIGS. 1 to 4. In the example of the second embodiment, the display control unit 404 performs different controls according to shift information of the vehicle 1 as vehicle information.

### (In Case of Driving)

First, control at the time of driving will be described with reference to FIG. 14. FIG. 14 is a flow diagram illustrating an example of a control procedure at the time of driving by the display control unit 404 according to a second embodiment.

When the shift information of the vehicle 1 is drive (D), that is, when a gear of the vehicle 1 is shifted to drive, the display control unit 404 displays the forward position of the vehicle 1 after a predetermined time on the bird's-eye view image data. Such shift information is transmitted from, for example, the shift sensor 21 (see FIG. 3) to the ECU 14 as an operation signal of a shift lever.

As illustrated in (a) of FIG. 14, when the user touches an arbitrary position of the area of the display device 8 where the bird's-eye view image data is displayed, the operation receiving unit 407 receives such an operation, and as illustrated in (b) of FIG. 14, the display control unit 404 displays a ghost display icon 57f as display information at the touch position of the display device 8. Here, ghost display means that the forward position of the vehicle 1 after a predetermined time is displayed as a transparent image of a vehicle icon.

The ghost display icon 57f includes a mark in which a vehicle icon and a ghost image are superimposed, a mark in which two inverted “V” letters are superimposed, and a finger mark attached thereto. These marks include information indicating a control event that may occur when the user further performs an operation and the operation receiving unit 407 receives the operation. Here, the control event is ghost display control of the forward position of the vehicle 1 after a predetermined time. Here, the operation received by the operation receiving unit 407 is upward sliding or dragging.

When the user performs upward sliding or dragging according to the ghost display icon 57f, the operation receiving unit 407 receives such an operation, and as illustrated in (c) of FIG. 14, the display control unit 404 displays a ghost image of the forward position of the vehicle 1 after a predetermined time so as to be superimposed on the bird's-eye view image data indicating a current position of the vehicle 1.

### (In Case of Backing)

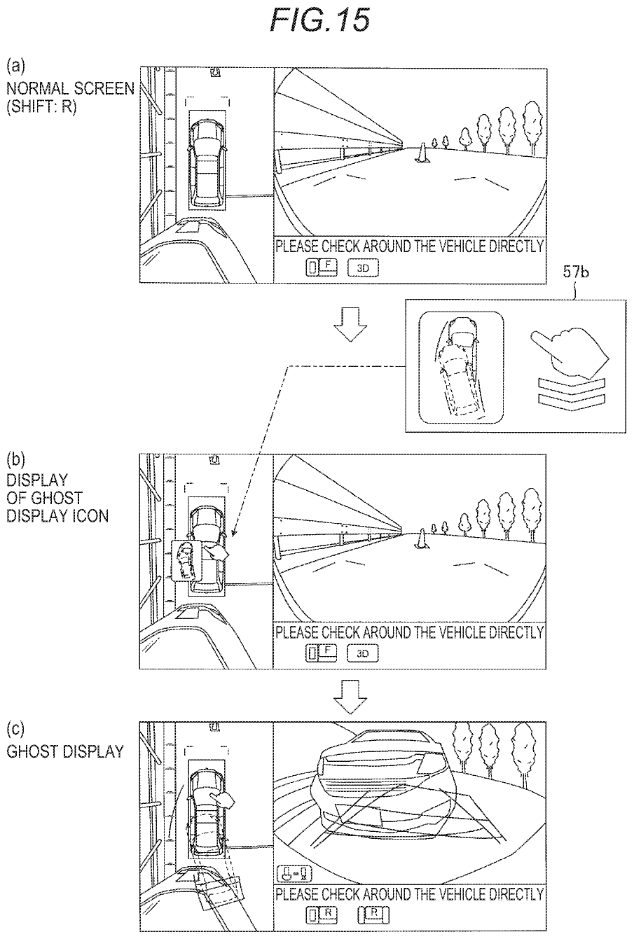

Next, control at the time of backing will be described with reference to FIG. 15. FIG. 15 is a flow diagram illustrating an example of a control procedure at the time of backing by the display control unit 404 according to the second embodiment.

When the shift information of the vehicle 1 is reverse (R), that is, when the gear of the vehicle 1 is shifted to reverse, the display control unit 404 displays the backward position of the vehicle 1 after a predetermined time on the bird's-eye view image data.

That is, as illustrated in (a) of FIG. 15, when the user touches an arbitrary position of the area of the display device 8 where the bird's-eye view image data is displayed, the operation receiving unit 407 receives such an operation, and as illustrated in (b) of FIG. 15, the display control unit 404 displays a ghost display icon 57b as display information at the touch position of the display device 8. Here, ghost display means that the backward position of the vehicle 1 after a predetermined time is displayed as a transparent image of a vehicle icon.

The ghost display icon 57b includes a mark in which a vehicle icon and a ghost image are superimposed, a mark in which two “V” letters are superimposed, and a finger mark attached thereto. These marks include information indicating a control event that may occur when the user further performs an operation and the operation receiving unit 407 receives the operation. Here, the control event is ghost display control of the backward position of the vehicle 1 after a predetermined time. Here, the operation received by the operation receiving unit 407 is downward sliding or dragging.

When the user performs downward sliding or dragging according to the ghost display icon 57b, the operation receiving unit 407 receives such an operation, and as illustrated in (c) of FIG. 15, the display control unit 404 displays a ghost image of the backward position of the vehicle 1 after a predetermined time so as to be superimposed on the bird's-eye view image data indicating a current position of the vehicle 1.

### (In Case of Parking)

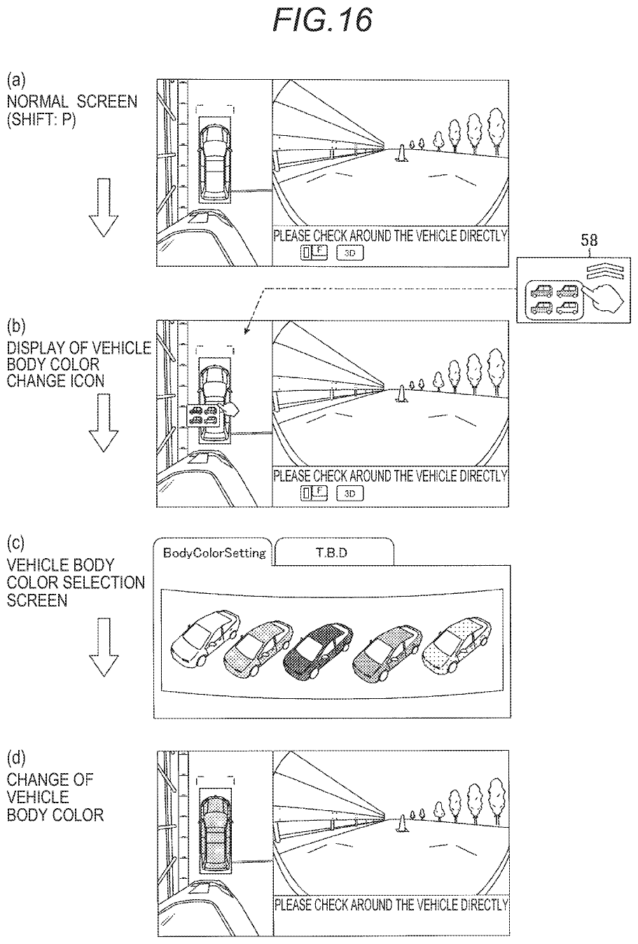

Next, control at the time of parking will be described with reference to FIG. 16. FIG. 16 is a flow diagram illustrating an example of a control procedure at the time of parking by the display control unit 404 according to the second embodiment.

When the shift information of the vehicle 1 is parking (P), that is, when the gear of the vehicle 1 is shifted to parking, the display control unit 404 performs control to allow the user to change the vehicle body color in the bird's-eye view image data.

That is, as illustrated in (a) of FIG. 16, for example, when the user touches an arbitrary position of the area of the display device 8 where the bird's-eye view image data is displayed, the operation receiving unit 407 receives such an operation and as illustrated in (b) of FIG. 16, the display control unit 404 displays a vehicle body color change icon 58 as display information at the touch position of the display device 8.

The vehicle body color change icon 58 includes a mark with vehicles having different vehicle body colors, a mark in which two inverted “V” letters are superimposed, and a finger mark attached thereto. These marks include information indicating a control event that may occur when the user further performs an operation and the operation receiving unit 407 receives the operation. Here, the control event is change control of the vehicle body color in the bird's-eye view image data. Here, the operation is upward sliding or dragging.

When the user performs upward sliding or dragging according to the vehicle body color change icon 58, the operation receiving unit 407 receives such an operation, and as illustrated in (c) of FIG. 16, the display control unit 404 performs transition from the display screen to a vehicle body color selection screen. The vehicle body color selection screen and selectable vehicle body colors are stored, for example, in the storage unit 406. When the user selects a predetermined vehicle body color on the vehicle body color selection screen, the operation receiving unit 407 receives such an operation and as illustrated in (d) of FIG. 16, the display control unit 404 returns to the screen on which the bird's-eye view image data is displayed before transition. At this time, the display control unit 404 displays the vehicle icon in the bird's-eye view image data in the vehicle body color which is selected by the user and is received by the operation receiving unit 407.

According to the ECU 14 of the second embodiment, the display control unit 404 performs different controls according to the shift information of the vehicle 1. Thus, it is possible to further improve the operability of displaying composite image data.

A display control device according to an aspect of this disclosure includes, for example, an image acquisition unit configured to acquire captured image data from an imaging unit that captures an image of a peripheral area of a vehicle, a display control unit configured to display, on a screen, display image data based on the captured image data, and an operation receiving unit configured to receive an operation on the screen, wherein the display control unit displays display information that reminds a first operation capable of being performed next via the operation receiving unit when the operation receiving unit receives designation of an arbitrary point of the display image data displayed on the screen.

Thus, as an example, it is possible to improve the operability of displaying the display image data.

The display information may further include information indicating first control performed when the operation receiving unit receives the first operation.

Thus, as an example, a user can intuitively understand an operation method and cause the display control unit to execute desired display control.

The display information may include information indicating enlargement or reduction as the information indicating the first control.

Thus, as an example, it is possible to remind the user about that the operation that the user can perform next is enlargement or reduction.

The display control unit may perform enlargement control or reduction control in display of the display image data when the operation receiving unit receives the first operation.

Thus, as an example, the user can cause the display control unit to execute display enlargement control or reduction control.

The display control unit may determine a display magnification of the display image data according to an amount of the received first operation.

Thus, as an example, the user can cause the display control unit to execute enlargement control or reduction control at an arbitrary magnification.

The display information may include, as the information indicating the first control, information indicating that scroll control of the display image data is possible.

Thus, as an example, it is possible to remind the user about that the operation that the user can perform next is scroll control of the display image data.

The display control unit may perform the scroll control of the display image data when the operation receiving unit receives the first operation.

Thus, as an example, the user can cause the display control unit to execute scroll control of the display image data.

The first operation may be sliding or dragging in a predetermined direction.

Thus, as an example, the user can cause the display control unit to execute enlargement control or reduction control by sliding or dragging.

The display information may include, as the information indicating the first control, information indicating that switching control in display of the display image data is possible.

Thus, as an example, it is possible to remind the user about that the operation that the user can perform next is display switching.

The display control unit may perform the switching control in the display of the display image data when the operation receiving unit receives the first operation.

Thus, as an example, the user can cause the display control unit to execute display switching control.

The display information may include, as the information indicating the first control, information indicating that control to change brightness of the display image data on the screen is possible.

Thus, as an example, it is possible to remind the user about that the operation that the user can perform next is change in the brightness on the screen.

The display control unit may perform control to change the brightness of the display image data on the screen when the operation receiving unit receives the first operation.

Thus, as an example, the user can cause the display control unit to execute control to change the brightness of the screen.

The display control unit may display the display information in which the first control to be performed is different according to vehicle information.

Thus, as an example, it is possible to remind the user about the operation that the user can perform next according to the vehicle information.

The vehicle information may be shift information of the vehicle.

Thus, as an example, it is possible to remind the user about the operation that the user can perform next according to the shift information of the vehicle.

The display control unit may display the display information at a designated position when the operation receiving unit receives designation on the screen.

Thus, as an example, it is possible to allow the user to perform various operations based on the designated position.

The display control unit may gradually change display on the screen when changing the display.

Thus, as an example, it is possible to obtain display consistency.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A display control device comprising:
an image acquisition unit configured to acquire captured image data from an imaging unit that captures an image of a peripheral area of a vehicle;
a display control unit configured to display, on a screen, display image data based on the captured image data; and
an operation receiving unit configured to receive an operation on the screen, wherein
the display control unit displays display information that reminds a first operation capable of being performed next via the operation receiving unit when the operation receiving unit receives designation of an arbitrary point of the display image data displayed on the screen.

2. The display control device according to claim 1, wherein
the display information further includes information indicating first control performed when the operation receiving unit receives the first operation.

3. The display control device according to claim 2, wherein
the display information includes information indicating enlargement or reduction as the information indicating the first control.

4. The display control device according to claim 1, wherein
the display control unit performs enlargement control or reduction control in display of the display image data when the operation receiving unit receives the first operation.

5. The display control device according to claim 4, wherein
the display control unit determines a display magnification of the display image data according to an amount of the received first operation.

6. The display control device according to claim 2, wherein
the display information includes, as the information indicating the first control, information indicating that scroll control of the display image data is possible.

7. The display control device according to claim 6, wherein
the display control unit performs the scroll control of the display image data when the operation receiving unit receives the first operation.

8. The display control device according to claim 1, wherein
the first operation is sliding or dragging in a predetermined direction.

9. The display control device according to claim 2, wherein
the display information includes, as the information indicating the first control, information indicating that switching control in display of the display image data is possible.

10. The display control device according to claim 9, wherein
the display control unit performs the switching control in the display of the display image data when the operation receiving unit receives the first operation.

11. The display control device according to claim 2, wherein
the display information includes, as the information indicating the first control, information indicating that control to change brightness of the display image data on the screen is possible.

12. The display control device according to claim 11, wherein
the display control unit performs control to change the brightness of the display image data on the screen when the operation receiving unit receives the first operation.

13. The display control device according to claim 2, wherein
the display control unit displays the display information in which the first control to be performed is different according to vehicle information.

14. The display control device according to claim 13, wherein
the vehicle information is shift information of the vehicle.

15. The display control device according to claim 1, wherein
the display control unit displays the display information at a designated position when the operation receiving unit receives designation on the screen.

16. The display control device according to claim 4, wherein
the display control unit gradually changes display on the screen when changing the display.

17. The display control device according to claim 7, wherein
the display control unit gradually changes display on the screen when changing the display.

18. The display control device according to claim 10, wherein
the display control unit gradually changes display on the screen when changing the display.

19. The display control device according to claim 12, wherein
the display control unit gradually changes display on the screen when changing the display.
